(19) United States
(12) Patent Application Publication
(10) Pub. No.: US 2006/0248216 A1
(43) Pub. Date: Nov. 2, 2006

(54) System and method for providing multimedia streaming service

(75) Inventor: Jin Park, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/412,850

(22) Filed: Apr. 27, 2006

(30) Foreign Application Priority Data
Apr. 27, 2005 (JP) 2005-35201

(51) Int. Cl. G06F 15/16

(52) U.S. Cl. 709/231

(57) ABSTRACT

A multimedia streaming service and method wherein when receiving a multimedia content request from a client, a multimedia content server packetizes the I frame of corresponding multimedia files to download the packetized I frame to the client through TCP. The client receives the I frame transmitted through TCP to sequentially store the received I frame in a key frame local buffer. Then, after completing the download of the I frame, the multimedia content server packetizes the P and B frames of corresponding multimedia file which then are transmitted through UDP. At this time, the multimedia content server provides a streaming service, through which the P and B frames are transmitted, to the client. The client outputs the P and B frames, which are now transmitted in the form of the streaming, as well as the previously stored I frame to a play-out buffer in accordance with the play-out algorithm. Therefore, the corresponding user can receive the multimedia service of high quality image with the waiting time reduced significantly.

### PRIORITY

This application claims priority to the benefit under 35 U.S.C. 119 (a) of an application entitled “System and Method for Providing Multimedia Streaming Service” filed in the Korean Industrial Property Office on April 27, 2005 and assigned Serial No. 2005-35201, the contents of which are incorporated herein by reference.

### BACKGROUND OF THE INVENTION

1. Field of the Invention

The present invention relates to a mobile communication system, more particularly to a system and a method for providing a multimedia streaming service in a mobile communication system.

2. Description of the Related Art

Recently, portable mobile communication terminals such as portable mobile phones and Personal Digital Assistants (PDAs) have been popularized. With the advancement of communication technology, such a mobile communication terminal can provide not only a call function but also a multimedia playback function. The multimedia playback function in the mobile communication terminal can be performed through a Video-On-Demand (VOD) service or by downloading and outputting multimedia contents thereto.

The VOD service can be realized through streaming. Streaming signifies a technology in which multimedia data including audio/video data are received and transmitted in real-time over the Internet without using a download scheme. Specifically, streaming is not a technology in which information is wholly downloaded at one time, but a technology in which information is continuously received little by little in the unit of a packet (for example, 0.5Mb), just enough to be adequately processed. Therefore, in a case of the streaming scheme, a user need not wait a long time for downloading all the multimedia contents. Also, the streaming need not be applied in strict real-time, and allows a delay as much as a buffering time. At present, IFTE Standards RFC2326 (Real-Time Streaming Protocol) and RFC1889 (Transport Protocol for Real-Time Applications) are generally used for streaming session management and for data packet transmission, respectively. Based on these standards, users can watch movies or dramas through the mobile communication terminals using the VOD service.

The multimedia download may be performed through a Transmission Control Protocol (TCP). Image quality is guaranteed to users by virtue of reliable transmission through the TCP, and a transmission rate of the TCP is determined by a throughput (T) as Equation (1):

$$T = \frac{s}{{t}_{RTT} ( \sqrt{\frac{2 p}{3}} + 12 \sqrt{\frac{3 p}{8}} p ( 1 + 32 {p}^{2} ) )} \qquad ( 1 )$$

wherein s is a packet size, p is a loss rate and t_{RTT} is a round trip time.

In the 3^{rd} Generation Partnership Project (3 GPP) TS 26.244 v6.0.0, there is proposed a progressive download standard according to which playback is possible even during download. In order to use the progressive download standard, however, a terminal must be configured pursuant to that standard, and audio and video tracks have to be properly interleaved with each other.

Although the TCP download guarantees image quality, it has a defect in that playback is impossible and users must wait until download is completed. Especially, since the TCP reflects temporal errors of a wireless channel to a TCP flow control to readjust a transmission rate in a wireless environment, it may incur an excessively long download time to users in the conventional wireless environment. In particular, additional performance deterioration may be caused by the TCP flow control which has reacted with temporal errors of a wireless channel in the wireless environment. Therefore, with less data to be transmitted, the more advantageous transmission through the TCP becomes.

The streaming technology need not wait for the download to complete, but has a drawback in that it cannot guarantee image quality because of unreliable transmission through a User Datagram Protocol (UDP). Especially, with the loss of an intra (I) frame, the error influence which propagates to other predictive (P) or bi-directional (B) frame through motion compression used for a compression algorithm, has a greater effect on image quality and synchronization than in a case of loss of a P or B frame.

In addition, the progressive download standard proposed in the 3 GPP TS 26.244 v6.0.0 has a limitation in that it cannot be applied to media which are constructed not according to restrictions specified in said standard.

As mentioned above, even in channels having the same probability of error occurrence, the more data to be transmitted over a corresponding channel, the higher probability becomes for loss of the TCP data transmission, so that TCP performance in the corresponding channel deteriorates. Also, in the conventional streaming transmission, the influence of loss of a key frame propagates to image quality. Accordingly, there is a desire to develop a technology for reliably transmitting multimedia contents.

### SUMMARY OF THE INVENTION

Accordingly, the present invention has been made to solve the above-mentioned problems occurring in the prior art, and an object of the present invention is to provide a system and a method for providing. a streaming service, in which user's waiting time is significantly shortened without loss of key frames.

In order to accomplish this object, according to one aspect of the present invention, there is provided a system for providing a multimedia streaming service, the system including a multimedia content server for packetizing I frames of a corresponding multimedia file and downloading the packetized I frames to a client through a TCP when the client requests multimedia contents to the multimedia content server, and packetizing P and B frames of the corresponding multimedia file and providing a streaming service for the packetized P and B frames to the client through a UDP when the TCP transmission of the I frames is completed; and at least one client for receiving and storing the I frames transmitted through the TCP, and then determining an order of reproducing the stored I frames, the P frames and the B frames to output the frames according to the determined order when receiving the P and B frames through the streaming service.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a structure of a multimedia streaming service system according to a preferred embodiment of the present invention;

FIG. 2 is a flowchart of messages for providing multimedia contents to a client in a multimedia streaming service system according to a preferred embodiment of the present invention;

FIG. 3 is a block diagram of a multimedia content server according to a preferred embodiment of the present invention; and

FIG. 4 is a block diagram of a client according to a preferred embodiment of the present invention.

### DETAILED DESCRIPTION OF THE PREFERRED EMBODIMENT

Hereinafter, preferred embodiments of the present invention will be described with reference to the accompanying drawings. In the following description and drawings, the same reference numerals are used to designate the same or similar components, and a detailed description of known finctions and configurations incorporated herein will be omitted when it may make the subject matter of the present invention unclear.

A video of multimedia contents generally consists of I, P and B frames. The I frames constitute most images of the video, and the P and B frames constitute motion parts of the video. Therefore, if the I frame suffers a loss, then image quality is deteriorated, whereas loss of P or B frame scarcely influences the image quality. According to the present invention, a key frame corresponding to the I frame of the video is transmitted separately from the P and B frames.

For this purpose, a multimedia content server according to a preferred embodiment of the present invention packetizes I frames of a corresponding multimedia file to download the packetized I frames to a client through a TCP when the client requests multimedia contents from the multimedia content server. The client receives the I frames transmitted through the TCP and sequentially stores the received I frames in a key frame local buffer. Then, after completing the download of the I frame, the multimedia content server packetizes the P and B frames of the corresponding multimedia file and then transmits the packetized P and B frames through a UDP. At this time, the multimedia content server provides a streaming service for the P and B frames to the client. The client outputs the already stored I frames as well as the P and B frames transmitted through the streaming to a play-out buffer in accordance with a play-out algorithm. Therefore, the user can be provided with a multimedia service having high image quality while waiting a very short time.

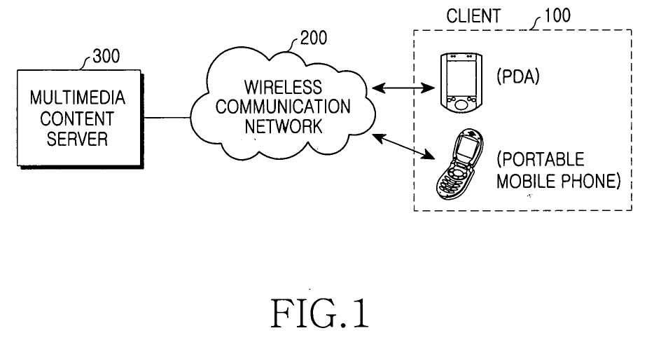

FIG. 1 illustrates a structure of a multimedia streaming service system according to a preferred embodiment of the present invention.

Referring to FIG. 1, a multimedia content server 300 provides the streaming service to a client 100 via a wireless communication network 200. The client 100, which may be a portable mobile phone or a PDA, supports wireless Internet protocols such as Wireless Application Protocol (WAP), Hyper Text Transfer Protocol (HTTP), etc., and multimedia service functions. The client can request the multimedia streaming service to the multimedia content server 300 via the wireless communication network 200. In order to provide the multimedia streaming services, the multimedia content server 300 stores various multimedia contents in the form of a database.

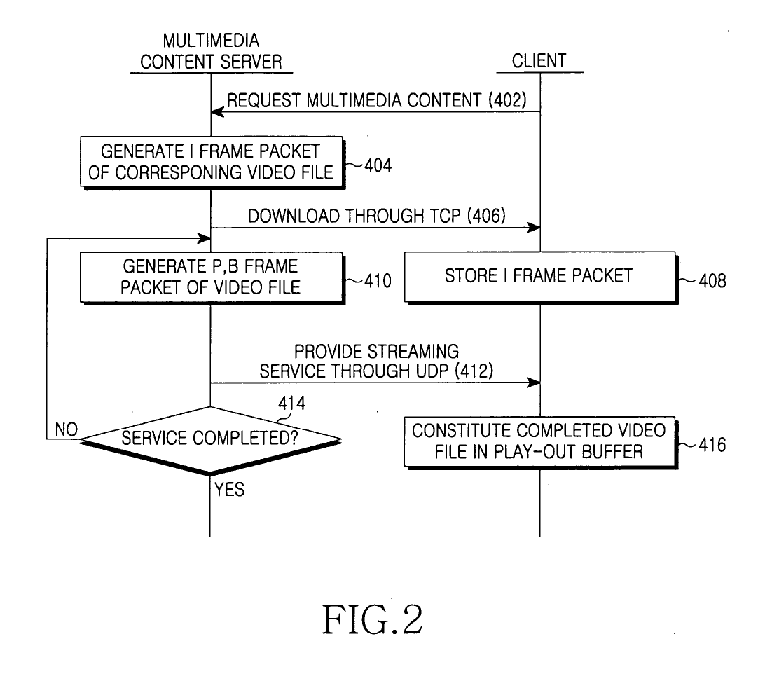

FIG. 2 is a flowchart of messages for providing multimedia contents to a client in a multimedia streaming service system according to a preferred embodiment of the present invention.

Referring to FIG. 2, in step 402, the client 100 requests a multimedia service, for example, a Voice On Demand (VOD) service to a multimedia content server 300 in accordance with user's selection. Then, in step 404, the multimedia content server 300 generates a packet (I frame packet) from I frames of the requested multimedia file, for example, a video file. Next, in step 406, the multimedia content server 300 downloads the I frame packet to the client 100 through a TCP. More specifically, the multimedia content server 300 selects only the I frames from the video file in a first pass with the client 100 to assemble the I frame into the I frame packet and then transmits the assembled I frame packet to the client 100 through the TCP. In step 408, the client 100 stores the I frame packet, which has been transmitted through the TCP in the first pass, into its local memory.

Next, in step 410, the content server 300 generates a packet (P and B frames packet) from the P and B frames of the corresponding video file. Next, in step 412, the content server 300 provides the streaming service for the generated packet to the client 100 through a UDP. That is, in a second pass with client 100, the content server 300 selects the P and B frames from the video file to assemble the frames into a packet and then transmits the assembled packet to the client 100 through the UDP.

Then, in step 416, when the P and B frame packet having been transmitted through the UDP is provided by streaming, the client 100 disassembles the I frame packet and the P and B frame packet at the same time, and inserts the disassembled packets into a play-out buffer in accordance with a two pass play-out algorithm. In other words, the client 100 constructs an intact video file in the play-out buffer. The size of the play-out buffer is determined dependent on a key frame rate and a key frame size of the corresponding multimedia file. The two pass play-out algorithm is intended to determine a time point for insertion into the play-out buffer by adding or subtracting a time difference between the previously downloaded I frame and the subsequently streamed B and P frames.

Meanwhile, the client 100 may repeatedly play the same content as the previously played content. In this case, the client 100 has already stored the downloaded I frames of the content to be played because the content was previously played. Therefore, the client 100 can play the high quality content by streaming only the B and P frames of corresponding content without downloading the I frames again. Accordingly, although FIG. 2 shows that the download of the I frames and the streaming of the B and P frames are continuously performed, it is not necessary to continuously perform the download of the I frames and the streaming of the B and P frames.

Next, in step 414, the multimedia content server 300 determines if the corresponding streaming service is completed. If not completed, then the process goes back to step 410. Accordingly, the user can watch high quality multimedia reproduction without waiting for a long time.

Even if the client 100 does not receive the streaming service of the P and B frames after the download of the I frames, the client 100 can reproduce the corresponding media file through a local play using only the downloaded I frames without the B and P streaming. This is possible because the I frames constitutes most images of the video as mentioned above.

The above-mentioned method of the present invention can be embodied as a program to be computer-readably stored into a recording media (such as a CD a ROM, a RAM, a floppy disc, a hard disc, a magneto-optical disc, etc.).

Hereinafter, a description will be given for a structure and operations of the multimedia content server.

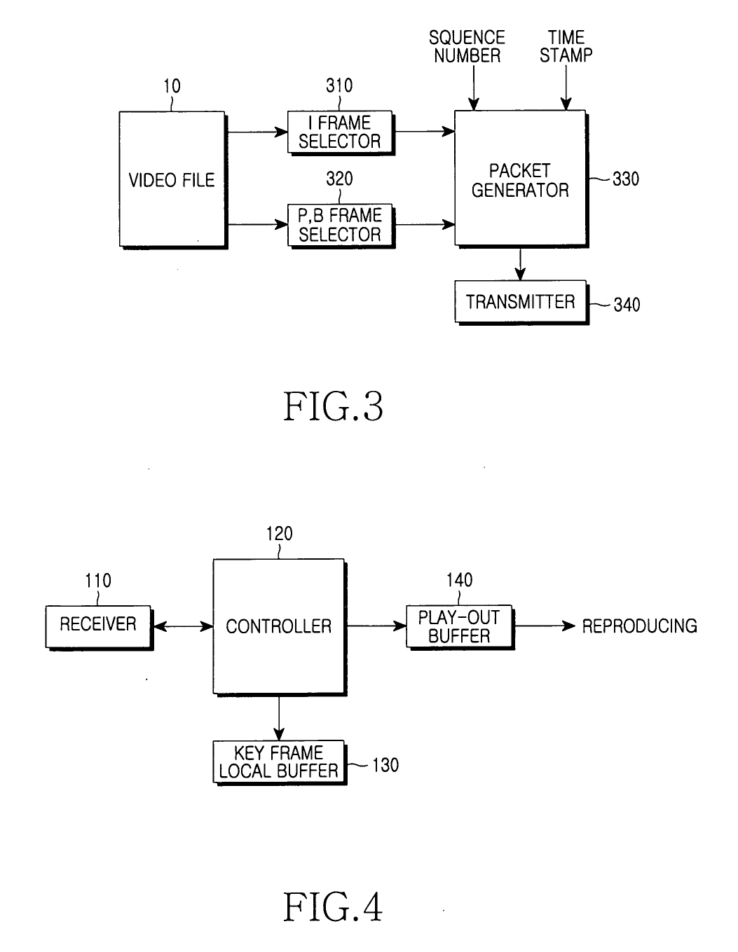

FIG. 3 is a block diagram of a multimedia content server according to a preferred embodiment of the present invention. Referring to FIG. 3, the multimedia content server 300 includes an I frame selector 310, a P and B frames selector 320, a packet generator 330 and a transmitter 340.

When receiving a multimedia service request from the client 100, the multimedia content server 300 (FIG. 1) transmits a key frame corresponding to I frames of a corresponding multimedia file separately from P and B frames thereof. Specifically, the I frame selector 310 selects the I frames from the multimedia file (for example, a video file 10), to provide the selected I frames to the packet generator 330. Then, the packet generator 330 generates a packet (i.e., I frame packet) using the I frames. At this time, the packet generator 330 derives a sequence number and a time stamp of the packet by adding a sequence number offset and a system time to a Relative Transmission Time (RTT) sequence number and a relative transmission time of the packet, which are acquired from a hint track of the corresponding video file, respectively, and then inserts the sequence number and the time stamp into the packet. The packet generator 330 transfers the generated I frame packet to the transmitter 340. Then, the transmitter 340 transmits the I frame packet to the client 100 via a TCP transport.

After the I frame packet is all transmitted to the client 100 in this way, the P and B frames selector 320 selects the P and B frames from the multimedia file (for example, the video file 10) to provide the selected P and B frames to the packet generator 330. Then, the packet generator 330 generates a packet (i.e., P and B frames packet) using the P and B frames, and then transmits the generated P and B frames packet to the transmitter 340. Next, the transmitter 340 provides a streaming service for the P and B frames packet to the client 100 through a UDP transport.

Hereinafter, a description will be given for a structure and operations of the client who receives such packets. FIG. 4 is a block diagram of a client according to a preferred embodiment of the present invention.

Referring to FIG. 4, the client 100 includes a receiver 110, a controller 120, a key frame local buffer 130 and a play-out buffer 140. When a request for a multimedia service is made from the user, the controller 120 of the client 100 transfers the request to the multimedia content server 300. When the request for a multimedia service is made from the user, the client 100 according to this embodiment of the present invention sends first a TCP download request and then a UDP streaming service request to the multimedia content server 300. According to the present invention, a key frame corresponding to I frames of the multimedia content is transmitted separately from P and B frames thereof. To this end, the client 100 may send a TCP download request for the I frames and a UDP streaming service request for the P and B frames to the multimedia content server 300, respectively. Of course, the multimedia content server 300 may provide the TCP download for the I frames and the UDP streaming service for the P and B frames, respectively without the request from the client 100.

As the multimedia content server 300 receives the TCP download request for the I frames from the client 100, it downloads the I frame packet to the client 100 through the TCP. When the packet transmitted from the multimedia content server 300 is received by the receiver 110, the controller 120 stores the received packet in the key frame buffer 130. Because the I frames plays an important role in the video as mentioned above, it is referred to as “the key frame” in the present invention. When the I frames have been transmitted completely in this way, the controller 120 requests a streaming session for the P and B frames to the multimedia content server 300. If the P and B frames are transmitted from the multimedia content server 300 through the UDP according to the request, then the controller 120 outputs the I frames stored in the key frame buffer 130 together with the P and B frames to the play-out buffer 140 based on a time calculated in accordance with the two pass play-out algorithm. As mentioned above, The two pass play-out algorithm is intended to determine a time point for insertion into the play-out buffer by adding or subtracting a time difference between the previously downloaded I frame and the subsequently streamed B and P frames.

Specifically, when the streaming for the P and B frames is effected, the two pass play-out algorithm determines first a time difference (Delta) by adding or subtracting system times when the I frames and the B and P frames having been transferred at different time points are sampled. Then, the controller 120 adds the Delta to a time stamp for the previously stored I frames, and selects and reproduce frames reaching their reproducing time point, from among the I, B and P frames. The user may watch the multimedia content which is reproduced through the play-out buffer 140, accordingly.

At this time, it is not necessary to continuously perform the download of the I frames and the streaming of the B and P frames as mentioned above. However, the content can be played while the download of the I frames and the streaming of the B and P frames may be performed at almost all the same time. In this case, the image quality may be superior to that of the progressive download scheme.

As mentioned above, according to the present invention, the amount of data transmitted through the TCP is restricted to the key frame, so the TCP transmission time is significantly reduced. Also, the image quality can be highly improved by using the restoring capability of the Coder-Decoder (CODEC) to the maximum extent through reliable transmission of the key frame. Furthermore, the present invention can provide a system in which only a software module in addition to the server and the client provides the same effect as the progressive download to even contents to which the progressive download cannot be applied. Therefore, the user need not wait to complete the download of all the files, but has only to download the key frame, so the download time is significantly reduced. More specifically, for example, take a case where a buffering time is 3 sec during the streaming, a file size is 3 Mbytes, each key frame is 3 Kbyte, a key frame rate is 3%, a TCP throughput is 15 K/sec and a header size is 20 byte.

Delay_{streaming}=3 sec

Delay_{TCPdownload}=6M/15k=400 sec

Delay_{KeyframeDownloadStreaming}=(180 k+1.2 k)/15 k+3=15 sec.

The key frame rate is 180 k because it is 3% of the total file size, 6 Mbyte. Each key frame is 3k, so the number of the key frame is 60. Accordingly, a header is 60*20 byte=1.2 k.

Therefore, if the total delay time is (180k +1.2k)/15k +3 =15 sec.

Therefore, according to the present invention, the total waiting time can be reduced significantly as compared with that taken for whole-file-download while a reliable multimedia service can be provided to the user.

While the invention has been shown and described with reference to certain preferred embodiments thereof, various changes in forms and details may be made within the scope of the present invention. Accordingly, the scope of the present invention should not be limited to the embodiments described in the specification but to the appended claims or its equivalents.

What is claimed is:

1. A system for providing a multimedia streaming service, the system comprising:
a multimedia content server for packetizing I frames of a corresponding multimedia file and downloading the packetized intra (I) frames to a client through a Transmission Control Protocol (TCP) when the client requests multimedia content from the multimedia content server, packetizing predictive (P) and bi-directional (B) frames of the corresponding multimedia file, and providing a streaming service for the packetized P and B frames to the client through a User Datagram Protocol (UDP) when the TCP transmission of the I frames is completed; and
at least one client for receiving and storing the I frames transmitted through the TCP, and determining an order for reproducing the stored I frames, the P frames and the B frames to output the frames according to the determined order when receiving the P and B frames through the streaming service.

2. The system as claimed in claim 1, wherein the client includes a key frame buffer for storing the I frames.

3. The system as claimed in claim 1, wherein the multimedia content server includes an I frame selector for extracting the I frames from the multimedia file and a P and B frames selector for extracting the P and B frames from the multimedia file.

4. The system as claimed in claim 3, further comprising a packet generator for assembling the I frames into a Real Time Protocol (RTP) packet if the I frames is received from the I frame selector.

5. The system as claimed in claim 4, wherein the packet generator assembles the P and B frames into an RTP packet if the P and B frames are received from the P and B frames selector.

6. The system as claimed in claim 5, further comprising a transmitter for downloading the I frame packet to the client through the TCP if the I frame packet is received from the packet generator, and for providing a streaming service to the client through the UDP if the P and B frame packet is received from the packet generator.

7. A method for providing a streaming service in a system including a multimedia content server and at least one client, the method comprising the steps of:
packetizing intra (I) frames of a multimedia file and downloading the packetized I frames through a Transmission Control Protocol (TCP) when at least one of the clients requests a multimedia content corresponding to the multimedia file from the multimedia content server;
receiving and storing the I frames transmitted through the TCP to the client;
packetizing P and B frames of the corresponding multimedia file and providing a streaming service for the predictive (P) and bi-directional (B) frames through a User Datagram Profile (UDP) if the multimedia content server completes the download of the I frame packet through the TCP; and
determining an order of reproducing the stored I frames, the P frames and the B frames to output the frames according to the determined order when the client receives the P and B frames through the streaming service.
